(19) United States
(12) Patent Application Publication
(10) Pub. No.: US 2013/0276096 A1
(43) Pub. Date: Oct. 17, 2013

(54) MANAGEMENT OF DATA PROCESSING SECURITY IN A SECONDARY PROCESSOR

(71) Applicant: ARM LIMITED, Cambridge (GB)

(72) Inventors: Dominic Hugo SYMES, Cambridge (GB); Ola HUGOSSON, Lund (SE); Donald FELTON, Ely (GB); Erik PERSSON, Lund (SE)

(73) Assignee: ARM LIMITED, Cambridge (GB)

(21) Appl. No.: 13/777,309

(22) Filed: Feb. 26, 2013

(30) Foreign Application Priority Data
Apr. 17, 2012 (GB) 1206760.9

(51) Int. Cl. G06F 21/60

(52) U.S. Cl. CPC G06F 21/606
USPC 726/16

(57) ABSTRACT

A data processing apparatus is configured to perform secure data processing operations and non-secure data processing operations, wherein the apparatus includes a master device with a secure domain and a non-secure domain. Components of the master device operate in the secure domain when performing secure data processing operations and operate in the non-secure domain when performing the non-secure data processing operations. A slave device is configured to perform a delegated data processing operation specified by the master device and a communication bus connecting the master device to the slave device. The delegated operation is initiated by an issuing component in the master device, wherein the slave device includes a security inheritance mechanism configured to cause the delegated operation to inherit a non-secure security status or a secure status depending upon whether the issuing component in the master device is operating in the non-secure domain or the secure domain.

### FIELD OF THE INVENTION

The present invention relates to data processing apparatuses comprising a master device and a slave device. More particularly the present invention relates to such data processing apparatuses in which the slave device is configured to perform secure data processing operations and non-secure data processing operations on behalf of the master device.

### BACKGROUND OF THE INVENTION

It is known to provide a data processing apparatus having a master device in overall control of the data processing apparatus and a slave device configured to perform data processing operations delegated to it by the master device. For example, in a data processing apparatus which is required to perform video decoding operations, a master device (e.g. a general purpose CPU) may delegate much of the video decoding operations to a dedicated video processing unit (i.e. the slave device).

Data security is further known to be an important consideration when configuring a contemporary data processing apparatus. For example, it is known to categorise some data as “secure” and other data as “non-secure”, whereby the secure data is only allowed to be accessed by components within a data processing apparatus which are trusted (i.e. secure). Accordingly a general purpose processor (such as the above mentioned CPU) may be configured to have a secure domain and a non-secure domain, wherein only components which reside in the secure domain of the processor are allowed to access secure data in memory. For example, the TrustZone® technology developed by ARM Limited of Cambridge, UK provide mechanisms for enforcing such security boundaries in a data processing apparatus (as described for example in U.S. Pat. No. 7,849,310, the entire contents of which are incorporated herein by reference).

The secure domain of such a data processor must be carefully constructed and administered to ensure that the security which it is intended to provide is maintained. One aspect of maintaining the trusted status of the secure domain is that any program code (e.g. a driver) which is to be executed within the secure domain must itself be trusted and carefully checked to ensure that its execution will not jeopardise the integrity of the secure domain. Accordingly, it is common for dedicated driver code to be written to provide a secure driver within the secure domain and to provide separate program code for a non-secure driver executing in the non-secure domain. Following this approach driver code can be written which is appropriately configured for the security domain in which it operates and with respect to the processing tasks which it delegates to a slave device, but this has the disadvantage that two or more versions of the driver program code must be written.

### SUMMARY OF THE INVENTION

Viewed from a first aspect, the present invention provides a data processing apparatus configured to perform secure data processing operations and non-secure data processing operations, wherein secure data in said data processing apparatus cannot be accessed by said non-secure data processing operations, the data processing apparatus comprising:

a master device comprising a secure domain and a non-secure domain, wherein components of said master device are configured to operate in said secure domain when performing said secure data processing operations and to operate in said non-secure domain when performing said non-secure data processing operations;

a slave device configured to perform a delegated data processing operation specified by said master device; and

a communication bus connecting said master device to said slave device,

wherein said delegated data processing operation is initiated by an issuing component in said master device issuing a delegated task definition to said slave device on said communication bus,

wherein said slave device comprises a security inheritance mechanism configured to cause said delegated data processing operation to inherit a non-secure security status if said issuing component in said master device is operating in said non-secure domain and to cause said delegated data processing operation to inherit a secure security status if said issuing component in said master device is operating in said secure domain.

The master device and the slave device in the data processing apparatus are coupled together by means of a communication bus which the master device can use to issue a delegated task definition to the slave device, the task definition setting out various parameters of a data processing operation which the master device is instructing the slave device to perform on its behalf. Whilst the issuing component in the master device which issues the delegated task definition to the slave device on the communication bus is free to define various parameters which configure the delegated data processing operation, the slave device is configured to have a security inheritance mechanism which causes the delegated data processing operation to inherit a non-secure security status if the issuing component is operating in the non-secure domain of the master device. Equally, the security inheritance mechanism of the slave device is configured such that by default the delegated data processing operation will inherit a secure security status if the issuing component is operating in the secure domain of the master device. In other words, the effect of the security inheritance mechanism is that the issuing component in the master device is generally able to specify all aspects of the delegated task definition which configures the delegated data processing operation to be carried out other than its security status. This security status is inherited from the security domain in which the issuing component is operating in the master device.

In this manner, a highly secure, hardware-enforced mechanism is provided for ensuring that only a trusted issuing component operating in the secure domain of the master device is able to cause a secure data processing operation to be performed by the slave device. Furthermore, because the security status of the delegated data processing operation is an integral part of the hardware configuration of the data processing apparatus, this aspect of the issuing component in the master device is no longer part of the configuration of that issuing component. For example, when the issuing component is a driver being executed in either the secure domain or the non-secure domain of the master device, the same driver program code can be used for a range of different security configurations such as the driver being executed solely in the secure domain, the driver being executed solely in the non-secure domain, or a driver in the non-secure domain communicating with a secure driver in the secure domain. This is due to the fact that the security inheritance mechanism in the slave device ensures that the critical security boundary in the system (that non-secure operations are not allowed to access secure data) is enforced, without this having to form part of the issuing component's own configuration.

An indication of which security domain the issuing component in the master device is operating in could be passed to the slave device in a number of ways, but in one embodiment said communication bus is configured such that said delegated task definition is accompanied by a domain identifier, said domain identifier indicating if said issuing component in said master device is operating in said non-secure domain or if said issuing component in said master device is operating in said secure domain.

In some embodiments, said slave device is configured to perform said delegated data processing operation as one of said non-secure data processing operations if said domain identifier indicates that said issuing component in said master device is operating in said non-secure domain. Accordingly, the security inheritance mechanism in the slave device can be configured so that the slave device uses the domain identifier as its reference for deciding how to set the security status of the delegated data processing operation, in particular setting it as “non-secure” when the domain identifier received on the communication bus shows that the issuing component is operating in the non-secure domain of the master device.

In some embodiments said delegated task definition comprises a security status request, said security status request indicating whether said delegated data processing operation is requested by said issuing component to be performed as a secure data processing operation or as a non-secure data processing operation. Thus, the security inheritance mechanism of the slave device notwithstanding, the issuing component in the master device may be able to include a security status request in the delegated task definition indicating the security status with which the issuing component would like the slave device to perform the delegated data processing operation.

In some embodiments said slave device is configured to perform said delegated data processing operation as said non-secure data processing operation if said issuing component in said master device is operating in said non-secure domain, regardless of said security status request. In other words, even if an issuing component in the non-secure domain of the master device seeks to initiate a secure data processing operation in the slave device by including a secure security status request in the delegated task definition is sends on the communication bus, the security inheritance mechanism in the slave device will override this request and only allow a non-secure data processing operation to be set up.

In some embodiments said slave device is configured to override said security inheritance mechanism and to perform said delegated data processing operation in accordance with said security status request if said issuing component in said master device is operating in said secure domain. The security inheritance mechanism in the slave device is essentially provided as a way of ensuring that a non-secure issuing component in the master device can only set up non-secure data processing operations in the slave device. However, in a data processing apparatus in which trust is categorised as secure or non-secure, a secure issuing component in the master device is inherently trusted within such a system and it may be advantageous to allow a secure issuing component in the master device to freely specify whether the delegated data processing operation is handled as secure or non-secure, in particular because this allows the secure issuing component to establish non-secure delegated data processing operations within the slave device.

In some embodiments said issuing component in said master device is configured to issue a delegated task update command to said slave device on said communication bus, wherein said slave device is configured to reconfigure said delegated data processing operation in accordance with said delegated task update command. In this way, even after a delegated data processing operation has been established in the slave device, reconfiguration of that delegated data processing operation may be carried out by means of the delegated task update command issued by the issuing component in the master device.

In one such embodiment, if said issuing component in said master device is operating in said secure domain said delegated task update command is configurable to cause said delegated data processing operation to convert to being performed as one of said non-secure data processing operations by causing said secure security status to be converted to said non-secure security status. Hence, in this manner a secure issuing component can cause a secure delegated data processing operation to be converted to a non-secure delegated data processing operation.

In some embodiments said slave device is configured to store said delegated task definition in an entry of a task definition table, wherein said entry of said task definition table comprises a task security definition, wherein said task security definition defines whether said delegated data processing operation is performed as one of said non-secure data processing operations or as one of said secure data processing operations, wherein said task security definition comprises either said secure security status or non-secure security status, wherein if said issuing component in said master device is operating in said non-secure domain said task security definition cannot be set with said secure security status. Accordingly, a task definition table may be provided in the slave device to administer and store the delegated task definitions received from the master device. A task security definition indicating either the secure security status or the non-secure security status forms part of each entry in this task definition table. This allows the slave device to maintain correct administration of each delegated task definition in the table, in particular ensuring that a non-secure issuing component in the master device cannot cause an entry in the task definition table to be set with secure security status.

In one such embodiment, a component operating in said non-secure domain in said master device cannot modify said entry of said task definition table if said task security definition is set with said secure security status. Accordingly, a component operating in the non-secure domain of the master device is simply blocked from modifying entries which are set with secure security status. Further, the blocking of such an attempted modification also extends to any attempt by a component operating in said non-secure domain in said master device to create a delegated data processing operation in a task definition table entry which is marked as secure. It should be understood that the above described security inheritance mechanism does not cause the secure status of an existing task to be “downgraded” to non-secure merely because a non-secure component attempted to modify this task definition table entry. Such attempted accesses are simply blocked. The security inheritance mechanism only applies to the creation of a new task definition table entry.

Alternatively, in another such embodiment, a component operating in said non-secure domain in said master device can modify a selected portion of said entry of said task definition table if said task security definition is set with said secure security status, wherein said selected portion is configured to indicate a status of a communication channel between said master device and said slave device. Accordingly, even though a component in the non-secure domain of the master device is generally blocked from modifying an entry of the task definition table which is labelled as secure, it may be allowed to modify a limited selected portion of the entry which relates to the status of communication channel between the master device and the slave device. For example, this communication channel may be an interrupt mechanism wherein although a non-secure component cannot generally modify an entry in the task definition table, it may use a selected portion thereof to flag an interrupt request, for example indicating that a message stored in a shared area of memory should be accessed by the secure delegated processing operation to allow communication between the master and the slave device.

In some embodiments said delegated task definition further comprises a page table base address, wherein said slave device comprises a memory management unit configured to administer accesses to a memory from said slave device, said memory management unit configured to perform translations between virtual memory addresses used by said slave device and physical memory addresses used by said memory, wherein said translations are configured in dependence on said page table base address, said page table base address identifying a storage location in said memory of a set of descriptors defining said translations. Accordingly the memory management unit in the slave device can receive, as part of the delegated task definition, a page table base address in dependence on which the virtual to physical memory address translations are made and therefore the page table base address defines the regions of the memory to which the delegated data processing operation has access. In this way further control over the operation of the delegated data processing operation can be given to the issuing component in the master device.

In one such embodiment, when the slave device is configured to store the delegated task definition in an entry of a task definition table, said entry of said task definition table comprises said page table base address, and wherein a component operating in said non-secure domain in said master device cannot modify said page table base address if said task security definition is set with said secure security status. Accordingly, this provides an additional level of security control to the secure domain in the master device since only a component operating in the secure domain can modify page table base addresses within task definitions that are labelled as secure. Within the context of secure delegated data processing operations this has the further advantage that even though the delegated data processing operation is configured as secure, its access to the memory can be further defined (and in particular constrained) by the page table base address. This therefore means that a secure delegated data processing operation being carried out on the slave device does not necessarily need to be given access to all secure memory and therefore some secure areas of memory can be retained as only accessible to the secure domain of the master device. Equally, two secure delegated data processing operations need not have access to each other's data.

In some embodiments said issuing component in said master device is a driver configured to operate in either said secure domain or said non-secure domain. As previously mentioned above as an example, this has the advantage that the system designer need only provide one driver which can be executed in either the secure domain or the non-secure domain without consideration of the consequences in terms of security that this would have, due to the fact that the slave device has the security inheritance mechanism.

Alternatively the system designer may explicitly choose to write dedicated drivers for each domain and in such embodiments, said issuing component in said master device is a driver configured to operate in a selected domain of said secure domain and said non-secure domain.

The slave device may take a wide variety of forms, but in one embodiment said slave device is a video processing unit.

In one such embodiment said video processing unit is configured to perform video coding operations on multiple video streams. Accordingly in this context the ability of the master device to control the security of delegated data processing operations being carried out in the video processing unit means that the video coding operations may be performed according to either the secure or the non-secure status for different video streams. This for example enables some video streams (e.g. encrypted video streams) to be handled by the video processing unit in a secure manner, such that the integrity of these selected video streams is not jeopardised by the video processing unit also performing non-secure video coding operations on other video streams.

Viewed from a second aspect the present invention provides a data processing apparatus configured to perform secure data processing operations and non-secure data processing operations, wherein secure data in said data processing apparatus cannot be accessed by said non-secure data processing operations, the data processing apparatus comprising:

master device means comprising a secure domain and a non-secure domain, components of said master device means for operating in said secure domain when performing said secure data processing operations and for operating in said non-secure domain when performing said non-secure data processing operations;

slave device means for performing a delegated data processing operation specified by said master device means; and

communication bus means for connecting said master device to said slave device,

wherein said delegated data processing operation is initiated by an issuing component in said master device means issuing a delegated task definition to said slave device means on said communication bus means,

said slave device means comprising security inheritance means for causing said delegated data processing operation to inherit a non-secure security status if said issuing component in said master device means is operating in said non-secure domain and to cause said delegated data processing operation to inherit a secure security status if said issuing component in said master device means is operating in said secure domain.

Viewed from a third aspect the present invention provides a method of data processing in a data processing apparatus configured to perform secure data processing operations and non-secure data processing operations, wherein secure data in said data processing apparatus cannot be accessed by said non-secure data processing operations, the method comprising the steps of:

operating components of a master device in a secure domain when performing said secure data processing operations and operating components of said master device in said non-secure domain when performing said non-secure data processing operations;

performing in a slave device a delegated data processing operation specified by said master device;

connecting said master device to said slave device via a communication bus;

initiating said delegated data processing operation by an issuing component in said master device issuing a delegated task definition to said slave device on said communication bus; and

causing said delegated data processing operation in said slave device to inherit a non-secure security status if said issuing component in said master device is operating in said non-secure domain and causing said delegated data processing operation to inherit a secure security status if said issuing component in said master device is operating in said secure domain.

The above, and other objects, features and advantages of this invention will be apparent from the following detailed description of illustrative embodiments which is to be read in connection with the accompanying drawings.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus in one embodiment in which a video processing unit is provided to perform video coding operations on behalf of a general purpose CPU;

FIG. 2 schematically illustrates in more detail the configuration of the video processing unit of FIG. 1;

FIG. 3 schematically illustrates a data processing apparatus in one embodiment in which a graphics processing unit is provided to perform graphics processing operations on behalf of a CPU;

FIG. 4 schematically illustrates in more detail the configuration of the master MMU shown in FIG. 3;

FIG. 5 schematically illustrates a series of steps which may be taken in one embodiment in which a VPU is allocated a video decoding task to perform;

FIG. 6 schematically illustrates a series of steps which may be taken in a VPU in one embodiment;

FIG. 7 schematically illustrates a series of steps that may be taken in a data processing apparatus in one embodiment in which two-way communication occurs between a CPU and a video core in a VPU;

FIG. 8 schematically illustrates how a delegated task definition may be constructed and passed from a master CPU to a slave VPU in one embodiment;

FIG. 9 schematically illustrates various task definition parameters for a secure task and their accessibility by secure and non-secure components in a task definition table in one embodiment;

FIG. 10 schematically illustrates a series of steps which may be taken in a data processing apparatus in one embodiment in which a CPU delegates a video processing task to a VPU; and

FIG. 11 schematically illustrates a series of steps which may be taken in one embodiment in which a driver in a CPU seeks access to a task definition stored in a scheduler in a VPU.

### DESCRIPTION OF EMBODIMENTS

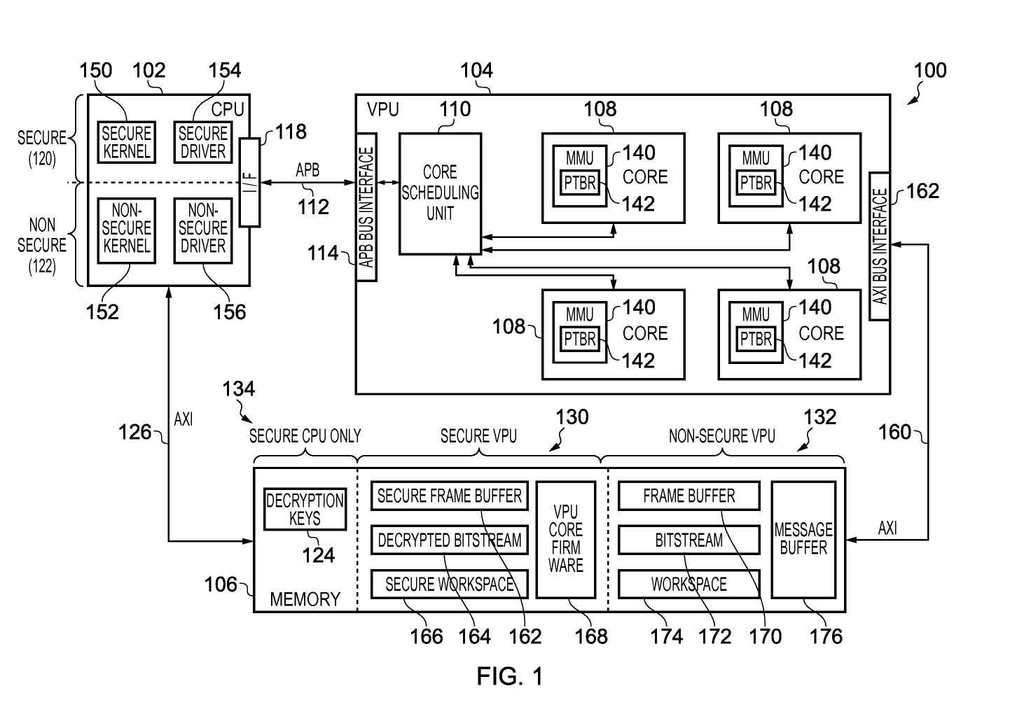

FIG. 1 schematically illustrates a data processing apparatus in one embodiment. This data processing apparatus 100 comprises a central processing unit (CPU) 102, a video processing unit (VPU) 104 and an external memory 106. The CPU 102 is a general purpose processing device, but the VPU 104 is specifically configured to efficiently perform video coding tasks. In particular, the CPU 102 and VPU 104 are configured such that the CPU 102 is the primary or master device in the data processing apparatus 100 whilst the VPU 104 is configured as a secondary or slave device which operates under the overall control of the CPU 102. Accordingly, when the CPU 102 determines that there is a video coding (i.e. encoding or decoding) task to be carried out it delegates this task to the VPU 104 which carries it out on behalf of the CPU 102.

In more detail, the VPU 104 has four processor cores 108 provided for the dedicated execution of video processing tasks. The distribution of video processing tasks to the video cores 108 is administered by the core scheduling unit 110. This core scheduling unit 110 in turn receives delegated task definitions from the CPU 102 over the APB 112. This APB 112 is an AXI Peripheral Bus (as provided by ARM Limited, Cambridge, UK). The APB 112 connects to the VPU 104 via the interfaces 114 and 118.

The CPU 102 is subdivided into a secure domain 120 and a non-secure domain 122. This subdivision of the CPU 102 into secure and non-secure domains may for example be provided in accordance with the TrustZone technology provided by ARM Limited of Cambridge, United Kingdom as described for example in U.S. Pat. No. 7,849,310, the entire contents of which are incorporated herein by reference. In essence, components within the secure domain 120 are trusted within the data processing apparatus 100, and therefore are allowed access to security-sensitive data within the data processing apparatus 100, whilst components in the non-secure domain 122 are not allowed access to such security-sensitive data. For example, within the memory 106 there may be stored decryption keys 124 which enable encoded data to be decrypted and are therefore examples of such security-sensitive data. The CPU 102 has access to the memory 106 via AXI bus 126 (as also provided by ARM Limited of Cambridge UK). Interfaces to the AXI bus 126 are not illustrated for clarity. In the same manner that the CPU 102 is subdivided into a secure domain 120 and a non-secure domain 122, the memory 106 is sub-divided into regions which may be specified as secure or non-secure. Most importantly, a component operating in the non-secure domain 122 of the CPU 102 cannot access a region of memory 106 which has been specified as secure. The reader is referred to the above mentioned description of the TrustZone® technology in U.S. Pat. No. 7,849,310 for further detail of how such access policing may be configured.

Furthermore, the video processing tasks delegated to the VPU 104 by the CPU 102 are also classified as either secure tasks or non-secure tasks, in dependence on the nature of the task and in particular the nature of the video stream which that task is required to perform video processing operations on. Thus, the VPU 104 is required to perform video processing tasks (in particular in this example embodiment video decoding tasks) on different video streams, some of which may be classified as secure. In this example embodiment a video stream is designated as secure if it is received as an encrypted bitstream and free access to the decrypted bitstream should not be allowed. For this reason, a video core 108 which is performing video processing tasks either performs its video processing tasks making use of a region of 130 of memory 106 which is dedicated to the “secure VPU” or to a region 132 of the memory 106 which is dedicated to the “non-secure VPU”. Most importantly therefore a video core 108 which is performing a non-secure video processing task should be prevented from accessing any region of memory which is defined as being secure. However, within the context of secure video processing tasks being carried out within the VPU 104, it would be undesirable to simply give a core 108 executing such a secure video processing task unlimited access to all secure regions of memory 106 because this would for example give that core access to a region of memory 106 such as that labelled 134 in which the decryption keys 124 are stored and should only be accessed by components operating within the secure domain 120 of the CPU 102. This is the case because although a component within the secure domain 120 of the CPU 102 may delegate a secure video processing task to a core 108 of the VPU 104, allowing that core to have full secure domain status, i.e. extending the secure domain 120 of the CPU 102 to include the video core 108 carrying out that secure processing task (at least for the duration thereof), would mean that the VPU 104 would have to run an operating system which is able to enforce the secure/non-secure subdivision in the same manner as is carried out in the CPU 102. However, a dedicated processing device such a VPU 104 typically does not have the facilities to run such an operating system.

The data processing apparatus 100 addresses this problem by enabling the CPU 102 to delegate video processing tasks to the VPU 104 which, as well as configurational parameters for the task, specify a page table base address which is used by a memory management unit (MMU) 140 within each video core 108 to perform translations between the virtual memory addresses used within each core 108 and the physical memory addresses used by the memory 106. Each MMU 140 is provided with one or more page table base registers (PTBR) 142 in which the page table base address for the processing task(s) to be carried out is(are) held.

Within the CPU 102, each of the two security domains 120 and 122 has its own kernel, namely secure kernel 150 and non-secure kernel 152. These kernels represent the core of the operating system running in each domain. In addition, as illustrated in FIG. 1, a driver is executing in each of the respective domains namely secure driver 154 and non-secure driver 156. These drivers are configured to interact with the VPU 104 and to delegate video processing operations thereto. Accordingly, it is the secure driver 154 which determines the page table base address which a video core 108 will have locally stored in the page table base register 142 of its MMU 140 when it carries out a secure video processing task on behalf of the CPU 102. Conversely, when a video core 108 is carrying out a non-secure video processing task on behalf of the CPU 102, either the secure driver 154 or the non-secure driver 156 may have set the page table base address in the respective page table base register 142, since both secure and non-secure parts of the CPU 102 are able to initiate non-secure video processing tasks in a video core 108. Significantly, the page table base address set in the page table base register 142 can only be set by a component running in the CPU 102 and these page table base addresses cannot be set by any firmware running on the VPU 104.

The memory 106 in FIG. 1 is schematically illustrated as being sub-divided into three portions 134, 130 and 132, respectively corresponding to: an area which may only be accessed by a secure component in the CPU; an area designated for use by a video core 108 performing a secure video processing task; and an area designated for use by a video core 108 performing a non-secure video processing task. The restriction of access to regions of memory 106 is enforced by two mechanisms. Firstly, only a video processing task which is designated as secure is able to pass an access request to the memory 106 via the AXI bus 160 and the AXI bus interface 162 (as enforced by the above-mentioned TrustZone® technology). Hence, a non-secure video processing task being carried out by a video core 108 cannot successfully carry out a memory access pertaining to the secure area 130 or 134.

The second mechanism by which control over access to particular regions of memory 106 is exercised is by means of the above mentioned page table base addresses. Since these page table base addresses provide the translation between the virtual memory addresses used within each video core 108 and the physical memory addresses used by the memory 106, appropriate setting of these page table base addresses (and of course the corresponding page tables and descriptors) can further constrain which areas of memory 106 are accessible to a given video core 108 in dependence on the video processing task it is carrying out. Hence, within the secure areas of memory 106, the area 134 can be reserved as an area which is only accessible to secure components operating within the CPU 102, whilst access can be granted to the secure VPU area 130 to secure video processing tasks being carried out by a video core 108. Example items which may be held in the secure VPU memory 130 whilst a secure video processing task is being carried out are the secure frame buffer 162, the decrypted bit stream 164 and the secure workspace 166. Additionally, it may commonly be the case that the firmware provided to configure the operation of the video cores 108 in VPU 104 is too large to be held within VPU 104 and accordingly this VPU core firmware 168 may also be held in the secure VPU memory area 130 (such that it is shielded from non-secure processors being executed by a video core 108). Equivalently, within the non-secure VPU memory area 132, a frame buffer 170, a bit stream 172 and a workspace 174 are examples of items which may be held in the this non-secure memory for use by a video core 108 when performing a non-secure video processing task. Additionally, a message buffer 176 is also held within the non-secure VPU memory area 132, this message buffer being used to provide a communication channel between the video cores 108 and the CPU 102. Being held in non-secure memory, either a secure or a non-secure processing task can access this message buffer to read or write a message as appropriate. Note that although a given video processing task may be carried out as a secure data processing operation, aspects of the administration of the task may nevertheless be handled by the non-secure driver 156 (removing this processing burden from the secure driver 154). For example in the illustrated embodiment, the non-secure driver 156 can manage the rate and progress of the video decode by sending messages to the secure session using message buffer 176. Example messages are “frame complete” or “input buffer empty”.

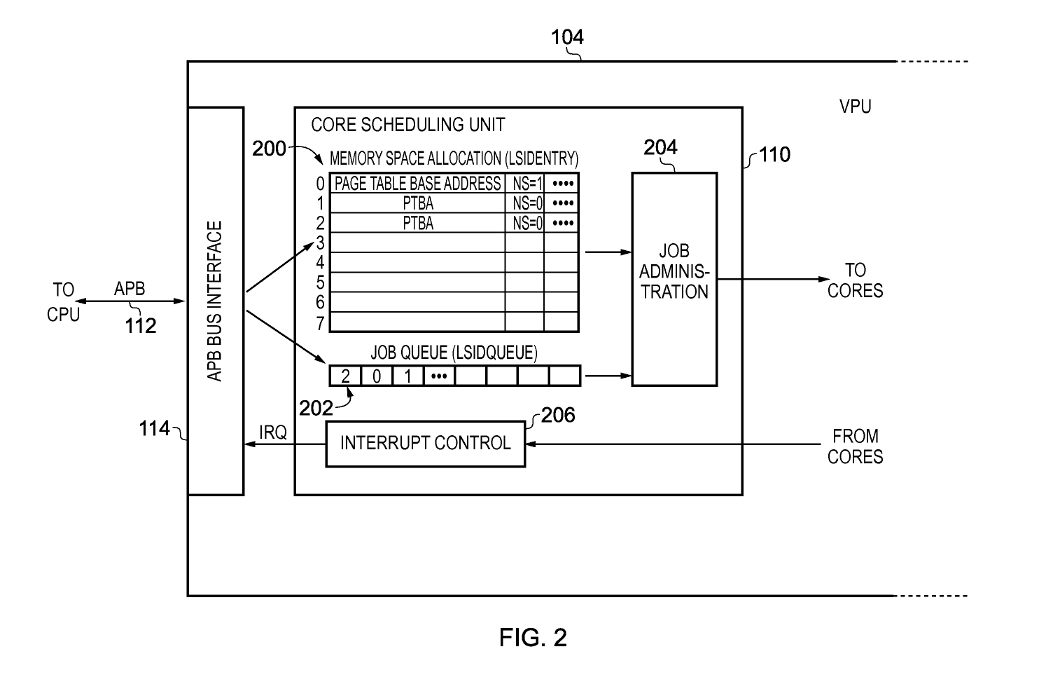

FIG. 2 schematically illustrates in more detail the configuration of some components of the video processing unit 104 shown in FIG. 1. In particular, more detail is given of the configuration of the core scheduling unit 110. The APB 112 and interface 114 are as described with reference to FIG. 1. When a driver (whether secure 154 or non-secure 156) running on CPU 102 (bus master) seeks to write a delegated task definition to the VPU 104 (bus slave) this takes place via the APB 112 and the interface 114. Within the VPU 104 the target of this write operation is the core scheduling unit 110. The core scheduling unit 110 comprises a memory space allocation table 200, a job queue 202 and a job administration unit 204, which administers the allocation of video processing tasks to the video cores 108. The configuration details of a given delegated task definition are stored in the memory space allocation table 200, in particular including a page table base address (PTBA) associated with the delegated task and a security bit (NS) defining whether the delegated task is to be carried out as secure task or a non-secure task. Other configuration parameters are also stored, some of which will be discussed in more detail later on in this description. When a delegated task definition is added to an entry of a memory space allocation table 200, an entry can thereafter also made in the job queue 202, indicating the order in which tasks defined in entries of the memory space allocation table should be executed as video cores become available. This updating of the job queue 202 may happen some time after the initial configuration of the memory space allocation table 200. For example, it is typical for the memory space allocation table 200 to be configured once at the start of decoding a video stream and then the job queue is updated while the stream is running (such as on a frame by frame basis). There is no need to add an entry to the job queue at the time the memory space allocation table is configured. The administration of the job queue 202 is handled by the non-secure driver 156, since the particular ordering which the jobs are executed is not security-critical. Accordingly, the job administration unit 204 refers to both the memory space allocation table 200 and the job queue 202 when selecting the next delegated data processing operation to be carried out by one of the video cores 108. A further component of the core scheduling unit 110 is the interrupt control 206 which is configured to receive interrupt signals from the video cores and to issue an interrupt signal (IRQ) to the CPU 102 via the APB 112. Note that there is no bus interface from the video cores to the core scheduler so the registers therein (which form the memory space allocation table 200 and the job queue 202) are only writable by an external bus master, i.e. the CPU 102.

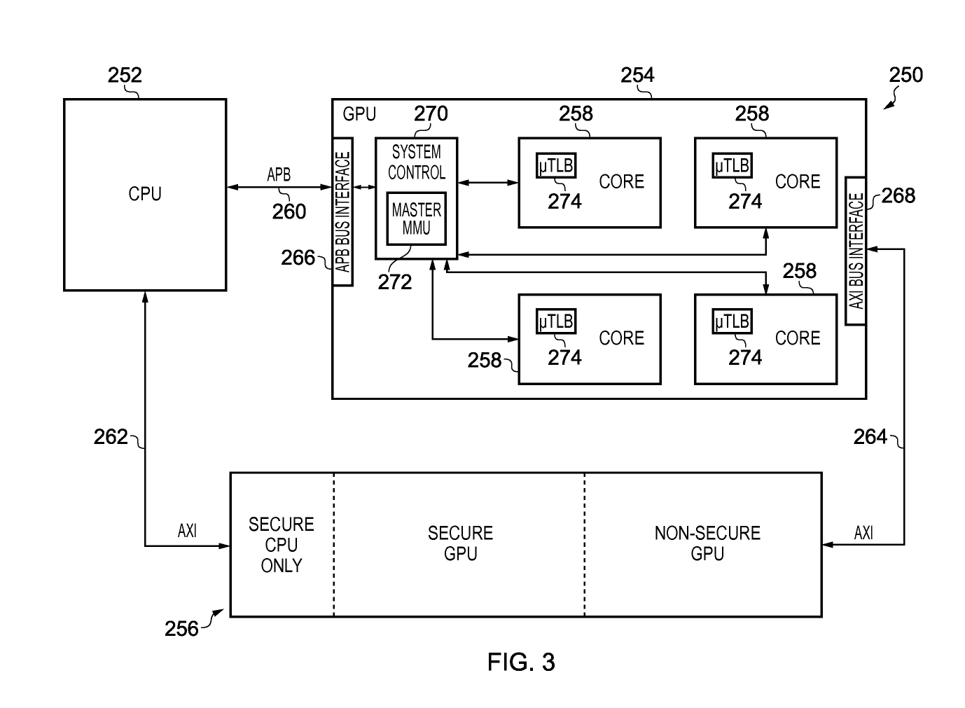

FIG. 3 schematically illustrates an alternative embodiment to that illustrated in FIG. 1, wherein the data processing apparatus 250 comprises a CPU 252, a graphics processing unit (GPU) 254 and a memory 256. The CPU 252 is configured in the same way as the CPU 102 in FIG. 1 and is not described further here. Similarly the memory 256 is configured like the memory 106 in FIG. 1, and the buses 260, 262 and 264 and the interfaces 266 and 268 are also configured like their counterparts in FIG. 1. Within the GPU 254, graphics processing cores 258 are provided which carry out graphics processing tasks delegated by the CPU 252.

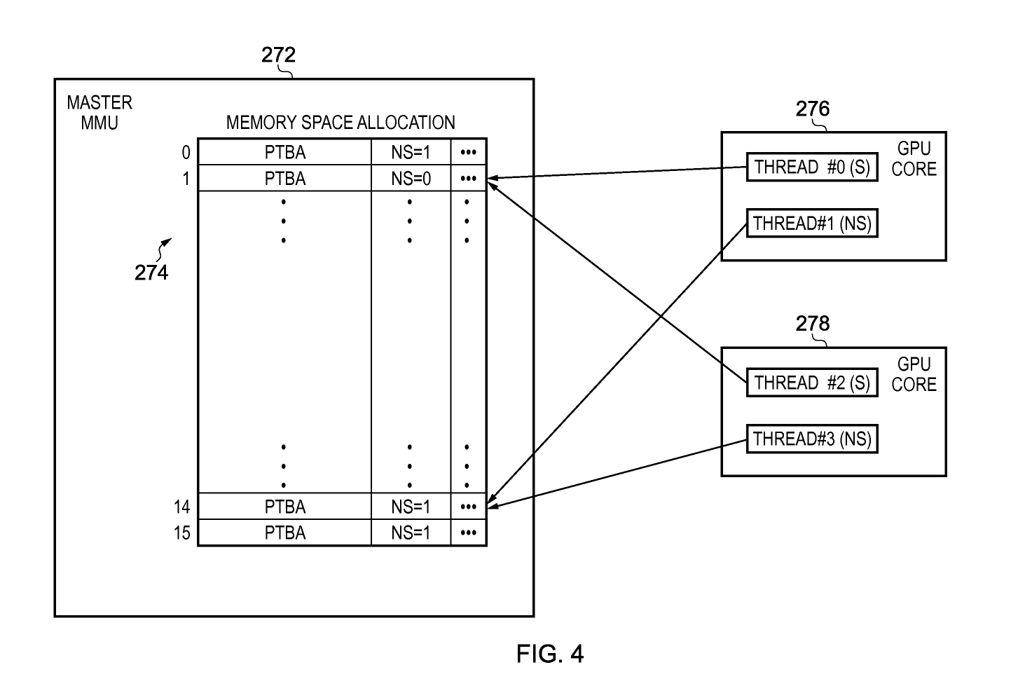

In the GPU 254, the system control unit 270 plays the role that the core scheduling unit 110 plays in the embodiment illustrated in FIG. 1. One difference to the core scheduling unit 110 is that the system control unit 270 comprises a master MMU 272 which provides a centralised administration of the virtual to physical address translations mentioned above. The master MMU 272 and system control unit 270 are configured to administer the control over which areas of memory 256 are accessible to the tasks being carried out by the graphics processing cores 258 on a thread basis, as will be described in more details with reference to FIG. 4. Because of the centralised master MMU 272, each graphics processor core 258 is provided with a micro-TLB 274, which each provide associated local storage for the relevant graphics processing core 258 to store copies of address translations recently performed by the memory management unit 272 for that processor core.

FIG. 4 schematically illustrates in more detail the configuration and operation of the master MMU 272 as shown in FIG. 3. The master MMU 272 and system control unit 270 administer the data processing tasks delegated to the GPU 254 on a thread basis. The master MMU 272 has a memory space allocation table 274 in which the configuration details of up to 16 delegated processing operations can be stored (in accordance with the delegated task definitions received from the CPU 252 over the APB 260). As before in the example of the memory space allocation table 200 within the core scheduling unit 110 in FIG. 2, the memory space allocation table 274 comprises page table base address information and security status information (as well as other configuration details) for each delegated task definition. Each such delegated task definition can be carried out by the generation of one or more threads which may be executed by one or more graphics processing cores. Hence, as illustrated in FIG. 4 the delegated task definition stored in entry 1 of the memory space allocation table 274 is a secure task which is being executed by thread #0 on GPU core 276 and the thread #2 on GPU core 278. Similarly, the delegated task definition that is stored in entry 14 of the memory space allocation table is being executed as thread #1 on GPU core 276 and thread #3 on GPU core 278. Accordingly, it will be appreciated that not only can two separate threads executing on different GPU cores operate with reference to one memory space allocation table entry, but also that within a given GPU core both secure and non-secure threads may execute simultaneously. In this manner, any given thread executing on a GPU core 258 may only access areas of memory 256 in accordance with the address translations provided by master MMU 272 (and possibly cached in micro-TLB 274) on the basis of the corresponding page table base address stored in the memory space allocation table 274.

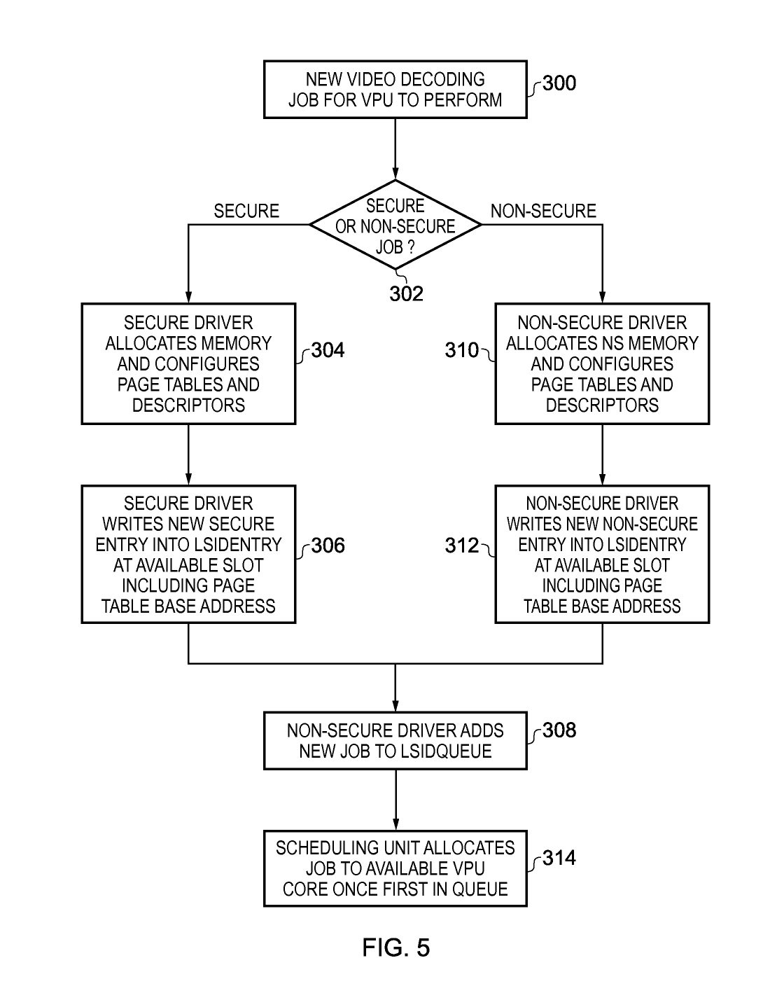

FIG. 5 schematically illustrates a series of steps which are taken in one embodiment in which a VPU (such as that illustrated in FIG. 1) is allocated a video decoding task to perform. The flow begins at step 300 when a new video decoding job exists for the VPU to perform on behalf of the CPU. At step 302 it is determined whether or not this video decoding job (task) should be handled as a secure task or not. Although a non-secure job can safely be handled as a secure job, in general only those tasks which explicitly need to be performed securely will be handled as secure tasks. Furthermore it may be the case that the video input for a non-secure job may come from a non-trusted component which does not have access to secure memory and so it may in any event not be practical to handle a non-secure job as a secure job. In the case of a secure task, the flow proceeds to step 304, wherein it is the secure driver 154 within the CPU 102 which allocates an area of secure memory (i.e. within the section 130 of the memory 106) and the secure driver further configures the page tables and descriptors accordingly to correspond to the allocated memory area. Then at step 306 the secure driver 154 writes a new secure entry into the register LSIDENTRY (i.e. into the memory space allocation table 200) at an available entry slot. This new entry is labelled as secure (NS=0) and includes the page table base address provided by the secure driver at step 304. The flow then proceeds to step 308.

Alternatively, if the new video decoding job to be performed can be handled non-securely then from step 302 the flow proceeds to step 310 whereby it is the non-secure driver 156 in the CPU 102 which allocates an area of non-secure memory to this task and configures the page tables and descriptors pointed to by a suitable page table base address to correspond to this allocated area of memory. Then at step 312 the non-secure driver 156 writes the new non-secure entry into LSIDENTRY (i.e. memory space allocation table 200) at an available slot including the page table base address defined at step 310. The entry is labelled as non-secure (i.e. NS=1). Note that the interface between the CPU 102 and the VPU 104 is such that a non-secure driver 156 cannot set the security status of an entry in the memory space allocation table to be secure. This mechanism described in more detail in the following. The flow then proceeds to step 308.

At step 308 the non-secure driver 156 adds the new job to the job queue 202 (LSIDQUEUE). In other words, the administration of the order in which the delegated video decoding tasks are carried out is administered by the non-secure driver 156, since this burden can be taken away from the secure driver 154 because it is not a security-critical task. Finally, at step 314 the core scheduling unit 110 (in particular by means of the job administration unit 204) allocates this job to an available VPU core 108 once it becomes first in the job queue 202.

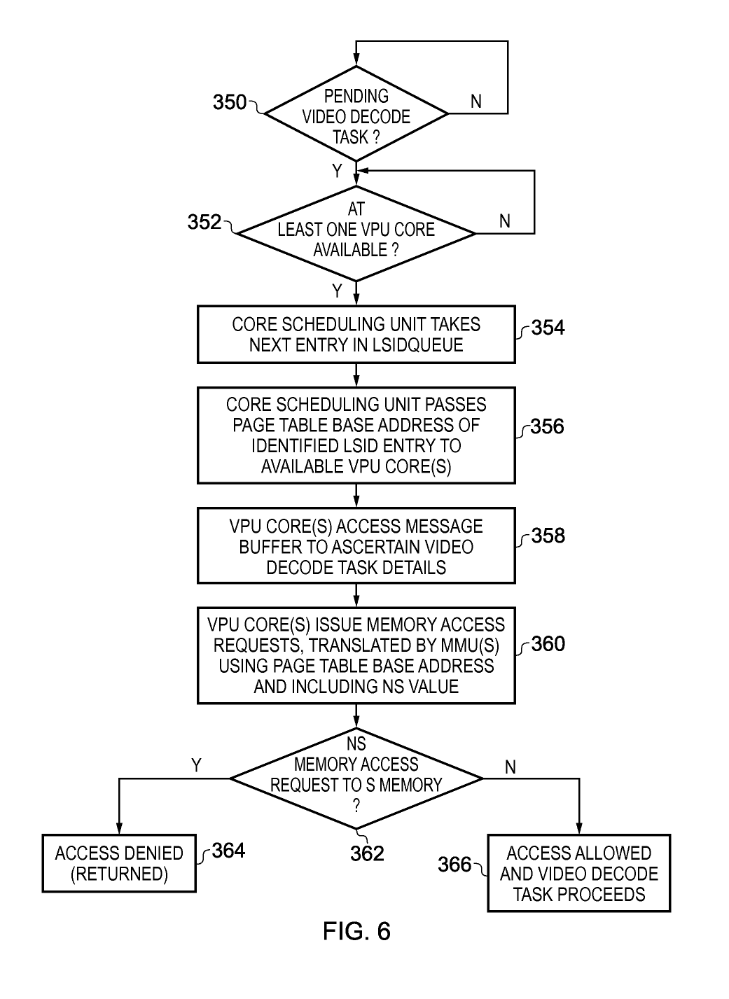

FIG. 6 schematically illustrates a series of steps taken in a VPU such as that illustrated in FIG. 1 in one embodiment. The flow begins at step 350 where it is determined if there is a pending video decode task to be carried out, i.e. if the job queue 202 indicates an entry in the memory space allocation table 200 which should be handled. Once this is the case the flow proceeds to step 352 where it is determined if there is at least one VPU core 108 available. Once this is the case then the flow proceeds to step 354. Here, the core scheduling unit 110 (specifically, the job administration unit 204) takes the next entry in the job queue (LSIDQUEUE) and at step 356, the core scheduling unit 110 passes the page table base address from the identified LSIDENTRY to the available VPU core (or cores, if the task is to be shared between more than one video core). Then at step 358, the VPU core accesses the message buffer 176 in the non-secure memory area 132 to ascertain further particular details of the video decode task to be carried out (for example the location of the bit stream in memory which is to be decoded). The flow then proceeds to step 360, where the VPU core begins carrying out this decoding task. This involves issuing memory access requests via the interface 162 and the AXI bus 160 to the memory 106, these memory access requests having being translated by the MMU 140 within the video core 108 using the page table base address stored in the relevant page table base register 142. The MMU allows each area of memory to be configured with one of four bus attribute configurations. The bus attribute configurations set policies such as security status and cache-ability. Importantly the bus attribute setting for each memory access requests are necessarily influenced by the NS value defined in the memory space allocation table 200 for this delegated task. One the one hand it is possible for a secure (NS=0) video task to make a non-secure bus access for certain memory areas (such as the message buffer). However, for a non-secure task the bus attribute is forced to be non-secure. The AXI access security, which is the deciding factor in whether a given memory access request is allowed to proceed, is taken from the bus attribute setting rather than the NS bit directly. In this manner, at step 362 it is determined if a non-secure memory access request is being made to a secure area of memory. As mentioned above, this policing of the physical division between the secure and non-secure worlds forms part of the hardware (i.e. bus interface 162 and the AXI bus 160), in this example in accordance with the TrustZone technology provided by ARM Limited, Cambridge, UK. Accordingly, if at step 362 it is determined that a non-secure memory access is seeking to access secure memory then the flow proceeds to step 364 where this access is denied and the memory access request is returned to its issuer. Alternatively, if the determination at step 362 is negative then the flow proceeds to step 366 where the access to memory is allowed and the video decoding task proceeds.

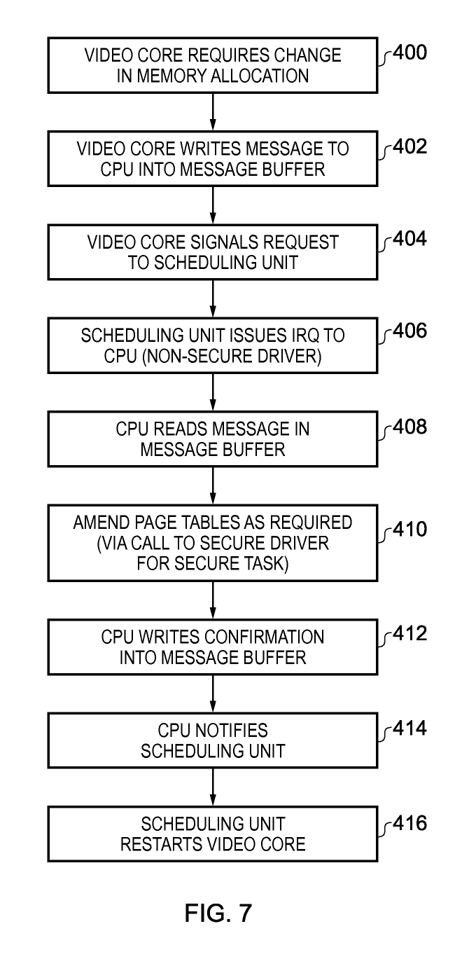

FIG. 7 schematically illustrates a series of steps which may be taken in one embodiment, which illustrates how a video core, such as one of the video cores 108 in FIG. 1, may communicate with the CPU 102. One reason why the video core may wish to communicate with the CPU 102 is if it requires a change in the memory allocation provided to it (step 400). For example, it may be the case that an initial memory allocation proves to be insufficient for the video decoding task that the video core 108 is seeking to perform and therefore a larger memory allocation must be requested. Thus, when a video core 108 requires such a change in memory allocation, it stops the video decoding that it is currently performing and the flow proceeds to step 402 where the video core 108 writes a message to the CPU 102 into the message buffer 176 in the non-secure area of memory 132. Then at step 404, the video core 108 signals through the core scheduling unit 110 that it wishes to notify the CPU 102 of this new message, which is to be done via means of an interrupt. Hence, at step 406 the core scheduling unit 110 (in particular the interrupt control 206) issues the corresponding interrupt (IRQ to the CPU 102 via interface 114 and APB 112). The receipt of this interrupt (which is handled by the non-secure driver 156) causes the CPU 102 to read the message which has been stored in the message buffer 176 (step 408). Then at step 410, either the non-secure driver itself amends the page tables as required to allocate more memory for a non-secure video decoding task, or the non-secure driver calls the secure driver 154 to amend the page tables as required to allocate more memory for a secure video decoding task. Once this is completed, the CPU 102 writes a confirmation message into the message buffer 176 (step 412) and then notifies the core scheduling unit 110 (step 414) that this has been done. Finally at step 416, the core scheduling unit 110 (in particular the job administration unit 204) signals to the corresponding video core that it can restart the video decoding task and can now make use of the additional memory allocated.

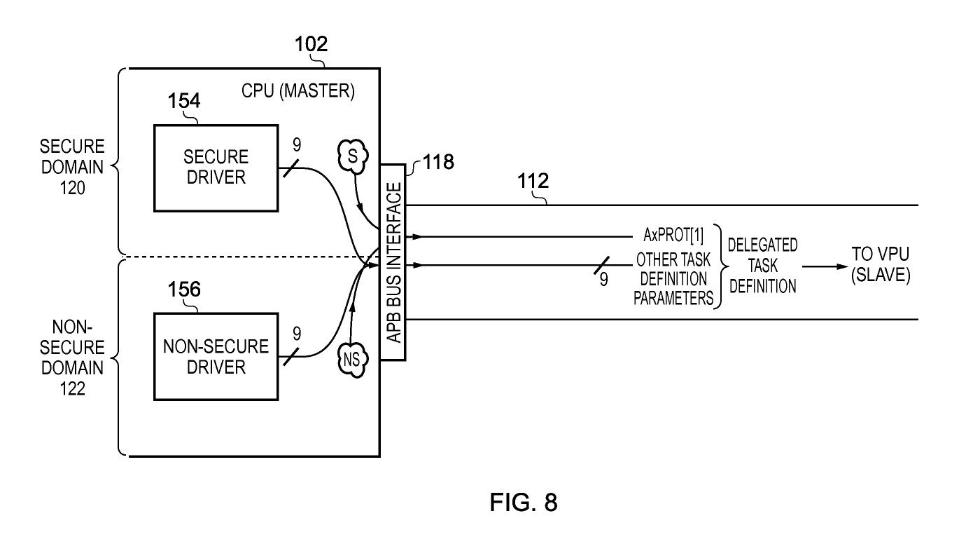

FIG. 8 schematically illustrates in more detail how a delegated task definition is constructed and passed from a CPU to a VPU in one embodiment, such as that illustrated in FIG. 1. The delegated task definition which a driver in the CPU 102 wishes to write to the VPU (not illustrated in FIG. 8) is (in this example embodiment) composed of ten definition parameters. As illustrated in FIG. 8, nine of these task definition parameters are provided by the driver which issues the delegated task definition i.e. either secure driver 154 or non-secure driver 156. However, the APB interface 118 by which the CPU 102 is coupled to the APB 112 is configured such that one task definition parameter of the delegated task definition, namely AxPROT [1], does not come from the driver issuing the delegated task definition but is provided by the domain in which the driver is operating. Accordingly, when non-secure driver 156 writes a delegated task definition (i.e. by constructing the nine task definition parameters which it has the freedom to set) onto the APB 112 the AxPROT value is automatically set to one (i.e. NS=1), indicating that this delegated task definition has been issued by a component operating in the non-secure domain. Conversely, when the secure driver 154 writes its nine task definition parameters, the AxPROT value is automatically set to zero (i.e. NS=0), indicating that this delegated task definition has been issued by a component operating in the secure domain. The delegated task definition is then passed to the VPU. A delegated task definition received by the VPU is added to a task definition such as the memory space allocation table 200 illustrated in FIG. 2.

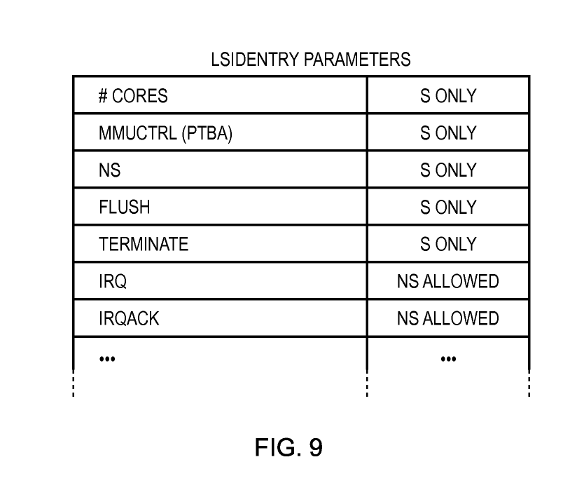

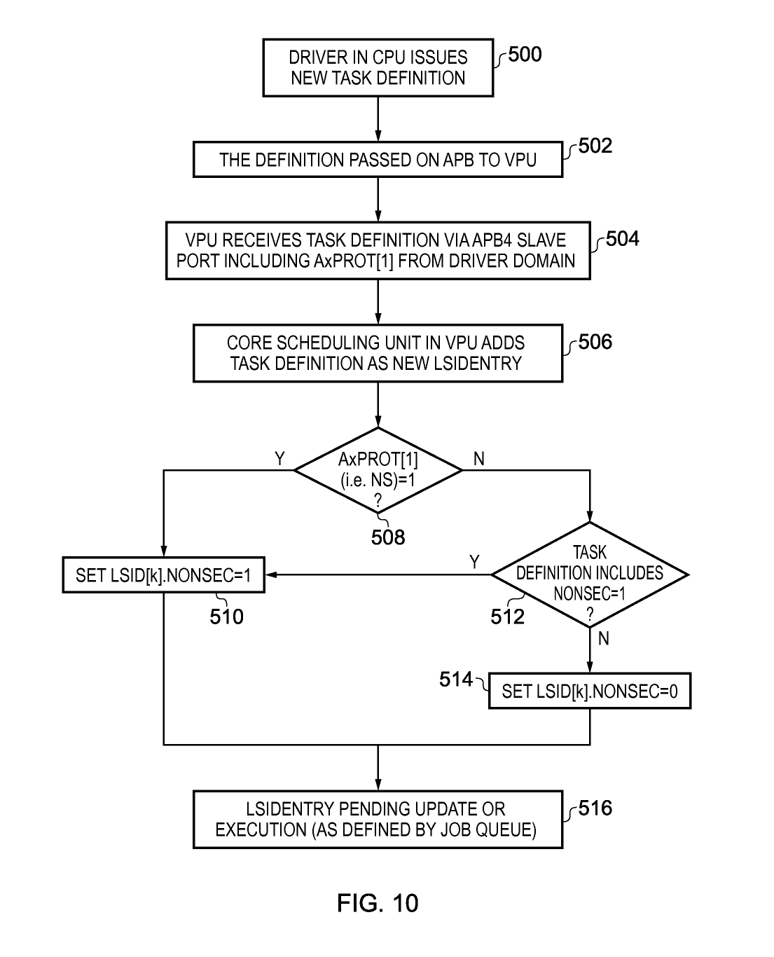

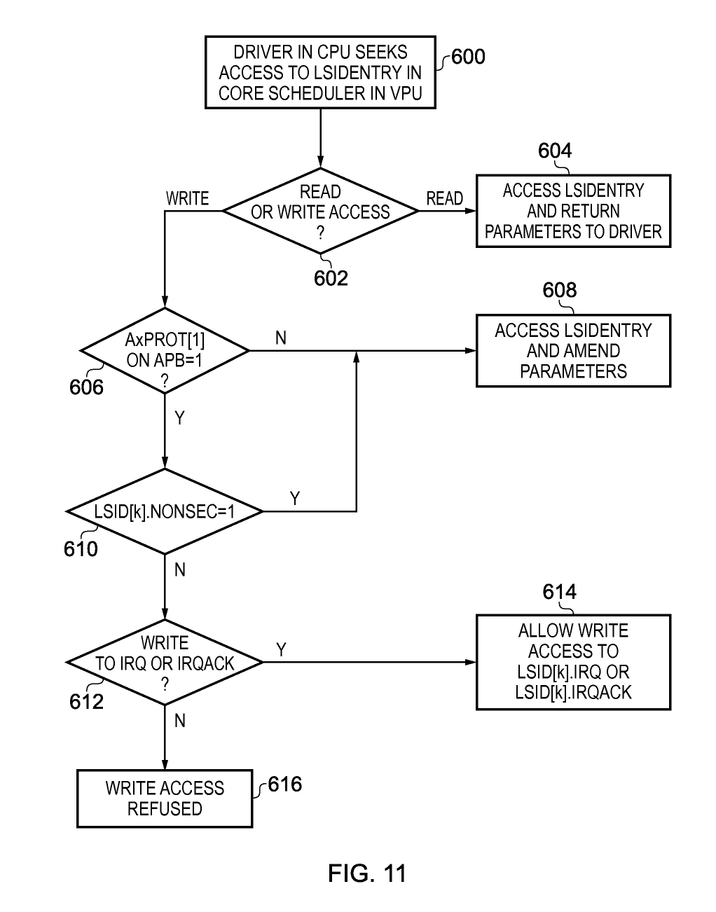

In addition to the page table base address and security bit, an LSIDENTRY has various other parameters as schematically illustrates in FIG. 9, which shows an example entry for a secure task. Once such a secure task is written into the task definition table, generally only a secure component operating in the secure domain 120 of the CPU 102 is allowed to amend these parameters, however as illustrated in FIG. 9, the IRQ and IRQACK parameters may also be amended by a non-secure component operating in the non-secure domain 122. As illustrated in FIG. 9, the LSIDENTRY parameters for a secure task which can only be amended by a secure component are #CORES (i.e. a value indicating the number of cores on which this task should be executed), MMUCTRL (the PTBA definition), the NS bit (defining the security status), FLUSH (by means of which a core can be caused to flush) and TERMINATE (by means of which an already executing job can be caused to prematurely terminate) are only amendable by a secure component. In the case of an LSIDENTRY for a non-secure task a non-secure secure component operating in the non-secure domain 122 is permitted access, with the usual provision that a non-secure secure component operating in the non-secure domain 122 cannot set the NS bit to NS=0 (secure status). The use and amendment of some of these parameters is described with reference to FIGS. 10 and 11.

FIG. 10 illustrates a series of steps which may be taken in one embodiment, showing how the issuance of a new task definition from the CPU is handled. The flow begins at step 500 where a driver (either secure or non-secure) in the CPU 102 issues a new task definition. This task definition is passed via the APB 112 to the VPU 104 (step 502). Importantly, the task definition received by the VPU 104 via its APB 4 slave port (i.e. interface 114) includes the AxPROT[1] value which has come from the driver domain as described above. Next at step 506, the core scheduling unit 110 in the VPU 104 adds this task definition as a new LSIDENTRY entry (i.e. into the memory space allocation table 200). At step 508, the core scheduling unit determines whether the value of AxPROT [1] is one or not (i.e. whether this a secure or a non-secure originating task definition). If it is a non-secure originating task definition then the flow proceeds to step 510 where LSID[k].NONSEC is set to one (i.e. the k^{th} entry in the set of LSIDENTRY values is set to 1 defining this is a non-secure task). Alternatively, if at step 508 it is determined that this is a secure domain originating task definition then the flow proceeds to step 512 at which it is determined whether the task definition includes an indication that the security of the task in the memory space allocation table 200 should be set as non-secure (i.e. if the task definition written by the issuing driver includes a parameter NONSEC=1). In other words, the task definition received from the CPU includes a security status request indicating the security status which the issuing component in the CPU wants the delegated task to have. As can be seen in FIG. 10, if the issuing component is within the non-secure domain then this information is never considered (i.e. an issuing component in the non-secure domain has no choice to set a task as secure). However, an issuing component in the secure domain does have the choice to set up a non-secure delegated task. Accordingly if the task definition includes this request for a non-secure status at step 512 then the flow proceeds to step 510 and the task is labelled as non-secure. Otherwise from step 512 the flow proceeds to step 514 where LSID[k].NONSEC is set to zero (i.e. the k^{th} entry in the set of LSIDENTRY values is set to 0 defining this is a secure task). The final step of the flow chain in FIG. 10 is step 516 where this new LSIDENTRY is then waiting to be executed on one of the VPU cores 108 (or to be updated by a subsequent access from the CPU 102 before it is executed). Accordingly, it will be appreciated that the configuration of the core scheduling unit 110 to perform the steps 508, 510, 512 and 514 described above represents a security inheritance mechanism whereby a delegated data processing operation scheduled within the core scheduling unit 110 inherits the security status of the domain in which the issuing component setting up that delegated data processing operation is itself operating. Hence, an issuing component in the non-secure domain can only be set up a non-secure task. Additionally however, the security status request which can be included in the task definition received on the APB 112 allows, only in the case of an issuing component in the secure domain of the CPU 112, to override this security inheritance mechanism and to set up a non-secure task in the core scheduling unit 110.

FIG. 11 illustrates a series of steps which may be taken in one embodiment, showing what happens when a driver in the CPU 102 seeks access to a parameter in a LSIDENTRY stored in the core scheduler of the VPU. Thus when such an access is sought (at step 600), the flow proceeds to step 602, where it is determined if the access is a read or a write request. Read access to LSIDENTRY parameters is freely allowed (step 604). If a write access is sought then the flow proceeds to step 606.

Here the AxPROT[1] value accompanying the access request on the APB 112 is examined and it is determined if the issuing component resides in the secure domain 120 of the CPU 102. If it does (i.e. AxPROT[1] is 0) then full write access to the LSIDENTRY is granted to this secure issuing component (e.g. secure driver 154) at step 608. If however AxPROT[1] is 1 (i.e. the request comes from a component such as non-secure driver 156 in the non-secure domain 122), then at step 610 it is determined what the security status is of the LSIDENTRY to which access is sought. If this LSIDENTRY is non-secure then the flow proceeds to step 608 and the write access is allowed. If on the other hand this LSIDENTRY is denoted as corresponding to a secure task, then only limited write access is permissible. Specifically, at step 612 it is determined if the write access is seeking to modify the IRQ or IRQACK parameters of this LSIDENTRY (by means of which a video core can signal a request for and acknowledge communication with the master CPU). Write access to these particular parameters is allowed (step 614), but all other write accesses are refused (step 616).

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A data processing apparatus configured to perform secure data processing operations and non-secure data processing operations, wherein secure data in said data processing apparatus cannot be accessed by said non-secure data processing operations, the data processing apparatus comprising:
a master device comprising a secure domain and a non-secure domain, wherein components of said master device are configured to operate in said secure domain when performing said secure data processing operations and to operate in said non-secure domain when performing said non-secure data processing operations;
a slave device configured to perform a delegated data processing operation specified by said master device; and
a communication bus connecting said master device to said slave device,
wherein said delegated data processing operation is initiated by an issuing component in said master device issuing a delegated task definition to said slave device on said communication bus, wherein said issuing component in said master device is a driver configured to operate in either said secure domain or said non-secure domain,
wherein said slave device comprises a security inheritance mechanism configured to cause said delegated data processing operation to inherit a non-secure security status if said issuing component in said master device is operating in said non-secure domain and to cause said delegated data processing operation to inherit a secure security status if said issuing component in said master device is operating in said secure domain.

2. The data processing apparatus as claimed in claim 1, wherein said communication bus is configured such that said delegated task definition is accompanied by a domain identifier, said domain identifier indicating if said issuing component in said master device is operating in said non-secure domain or if said issuing component in said master device is operating in said secure domain.

3. The data processing apparatus as claimed in claim 2, wherein said slave device is configured to perform said delegated data processing operation as one of said non-secure data processing operations if said domain identifier indicates that said issuing component in said master device is operating in said non-secure domain.

4. The data processing apparatus as claimed in claim 1, wherein said delegated task definition comprises a security status request, said security status request indicating whether said delegated data processing operation is requested by said issuing component to be performed as a secure data processing operation or as a non-secure data processing operation.

5. The data processing apparatus as claimed in claim 4, wherein said slave device is configured to perform said delegated data processing operation as said non-secure data processing operation if said issuing component in said master device is operating in said non-secure domain, regardless of said security status request.

6. The data processing apparatus as claimed in claim 4, wherein said slave device is configured to override said security inheritance mechanism and to perform said delegated data processing operation in accordance with said security status request if said issuing component in said master device is operating in said secure domain.

7. The data processing apparatus as claimed in claim 1, wherein said issuing component in said master device is configured to issue a delegated task update command to said slave device on said communication bus, wherein said slave device is configured to reconfigure said delegated data processing operation in accordance with said delegated task update command.

8. The data processing apparatus as claimed in claim 7, wherein if said issuing component in said master device is operating in said secure domain said delegated task update command is configurable to cause said delegated data processing operation to convert to being performed as one of said non-secure data processing operations by causing said secure security status to be converted to said non-secure security status.

9. The data processing apparatus as claimed in claim 1, wherein said slave device is configured to store said delegated task definition in an entry of a task definition table, wherein said entry of said task definition table comprises a task security definition, wherein said task security definition defines whether said delegated data processing operation is performed as one of said non-secure data processing operations or as one of said secure data processing operations, wherein said task security definition comprises either said secure security status or non-secure security status, wherein if said issuing component in said master device is operating in said non-secure domain said task security definition cannot be set with said secure security status.

10. The data processing apparatus as claimed in claim 9, wherein a component operating in said non-secure domain in said master device cannot modify said entry of said task definition table if said task security definition is set with said secure security status.

11. The data processing apparatus as claimed in claim 9, wherein a component operating in said non-secure domain in said master device can modify a selected portion of said entry of said task definition table if said task security definition is set with said secure security status, wherein said selected portion is configured to indicate a status of a communication channel between said master device and said slave device.

12. The data processing apparatus as claimed in claim 1, wherein said delegated task definition further comprises a page table base address,
wherein said slave device comprises a memory management unit configured to administer accesses to a memory from said slave device, said memory management unit configured to perform translations between virtual memory addresses used by said slave device and physical memory addresses used by said memory,
wherein said translations are configured in dependence on said page table base address, said page table base address identifying a storage location in said memory of a set of descriptors defining said translations.

13. The data processing apparatus as claimed in claim 12, wherein said slave device is configured to store said delegated task definition in an entry of a task definition table, wherein said entry of said task definition table comprises a task security definition, wherein said task security definition defines whether said delegated data processing operation is performed as one of said non-secure data processing operations or as one of said secure data processing operations, wherein said task security definition comprises either said secure security status or non-secure security status, wherein if said issuing component in said master device is operating in said non-secure domain said task security definition cannot be set with said secure security status, wherein said entry of said task definition table comprises said page table base address, and wherein a component operating in said non-secure domain in said master device cannot modify said page table base address if said task security definition is set with said secure security status.

14. The data processing apparatus as claimed in claim 1 wherein said issuing component in said master device is a driver configured to operate in a selected domain of said secure domain and said non-secure domain.

15. The data processing apparatus as claimed in claim 1 wherein said slave device is a video processing unit.

16. The data processing apparatus as claimed in claim 1 wherein said video processing unit is configured to perform video coding operations on multiple video streams.

17. A data processing apparatus configured to perform secure data processing operations and non-secure data processing operations, wherein secure data in said data processing apparatus cannot be accessed by said non-secure data processing operations, the data processing apparatus comprising:
master device means comprising a secure domain and a non-secure domain, components of said master device means for operating in said secure domain when performing said secure data processing operations and for operating in said non-secure domain when performing said non-secure data processing operations;
slave device means for performing a delegated data processing operation specified by said master device means; and
communication bus means for connecting said master device to said slave device,
wherein said delegated data processing operation is initiated by an issuing component in said master device means issuing a delegated task definition to said slave device means on said communication bus means, wherein said issuing component in said master device means is a driver configured to operate in either said secure domain or said non-secure domain,
said slave device means comprising security inheritance means for causing said delegated data processing operation to inherit a non-secure security status if said issuing component in said master device means is operating in said non-secure domain and to cause said delegated data processing operation to inherit a secure security status if said issuing component in said master device means is operating in said secure domain.

18. A method of data processing in a data processing apparatus configured to perform secure data processing operations and non-secure data processing operations, wherein secure data in said data processing apparatus cannot be accessed by said non-secure data processing operations, the method comprising the steps of:
operating components of a master device in a secure domain when performing said secure data processing operations and operating components of said master device in said non-secure domain when performing said non-secure data processing operations;
performing in a slave device a delegated data processing operation specified by said master device;
connecting said master device to said slave device via a communication bus;
initiating said delegated data processing operation by an issuing component in said master device issuing a delegated task definition to said slave device on said communication bus, wherein said issuing component in said master device is a driver configured to operate in either said secure domain or said non-secure domain; and
causing said delegated data processing operation in said slave device to inherit a non-secure security status if said issuing component in said master device is operating in said non-secure domain and causing said delegated data processing operation to inherit a secure security status if said issuing component in said master device is operating in said secure domain.
